(19) United States
(12) Patent Application Publication
(10) Pub. No.: US 2007/0269996 A1
(43) Pub. Date: Nov. 22, 2007

(54) HIGH FREQUENCY CONNECTOR

(75) Inventor: Chang che Chia, Taipei (TW)

Correspondence Address: LOWE HAUPTMAN HAM & BERNER, LLP, 1700 DIAGONAL ROAD, SUITE 300, ALEXANDRIA, VA, 22314, US

(73) Assignee: DONGGUAN COMAX ELECTTRONICS, LTD., Dongguan City (CN)

(21) Appl. No.: 11/748,645

(22) Filed: May 15, 2007

(30) Foreign Application Priority Data
May 18, 2006 (CN) 200610035506.1

(51) Int. Cl. H01R 12/00

(52) U.S. Cl. 439/66

(57) ABSTRACT

A high frequency connector, said connector comprising: an insulating body and a plurality of contacts; the insulating body having an inserting portion, a leading portion, and a plurality of slots disposed between the inserting portion and the leading portion for arranging the contacts, said contacts including first contacts and second contacts, and the first contacts being arranged in staggered pattern with the second contacts, wherein the differential characteristic impedance (Zdiff) of the contacts is around 100Ω±15% to improve the whole transmission efficiency.

### BACKGROUND OF THE INVENTION

1. Field of the Invention

The present invention relates to a high frequency connector, more particularly, relates to a high frequency board end connector having contacts satisfied a condition of the differential characteristic impedance value (Zdiff) between 100Ω±15%.

2. Description of the Related Art

Normally, at least a board end electrical connector is disposed on a circuit board or other board end interface for providing at least a cable end electrical connector to connect an external system by a cable. Said board end electrical connector comprising a plurality of contacts and said cable end electrical connector comprising a plurality of corresponding contacts are touched electrically respectively, when the cable end electrical connector is connected to the board end electrical connector therein.

In high frequency transmission system, the impedance matching between each of transmission pairs having two transmission lines is a very important control variable for maintaining the quality of high speed transmission, that is, the intervals between each of the transmission pairs should be equal as well as possible, in order to balance the electromagnetic interference effect therebetween.

However, the contacts are designed in different length corresponding to different configuration on a circuit board. FIG. 1 is the side view of the configuration of two contacts A1, A2 in a traditional electrical connector. Said contacts A1, A2 are configured in a plurality of solder pads on two different array of a circuit board respectively, wherein the contacts A1 are interposed between each of the contacts A2. Therefore, said contacts A1, A2 will generate a staggered distance in section B thereof while they are connected to a circuit board C respectively, for this reason, its impedance won't be able to maintain a equal distance matching. Furthermore, while the interval (pitch) between those two contacts is increased slightly, said impedance will be too big caused the block in transmission.

It is thus desirable to provide an electrical connector satisfied the requirements of ideal differential characteristic impedance which can resolve above problem in prior art.

### SUMMARY OF THE INVENTION

The object of the present invention is to provide a high frequency connector with excellent impedance characteristic, thus to improve the overall transmission efficiency.

In order to achieve the aforementioned object, the present invention is to provide a plurality of contacts fixed in slots of an electrical connector to touch electrically with a plurality of contacts of a corresponding electrical connector respectively. Said contacts form a plurality of transmission paths respectively, and, the distance of each of two transmission paths are equal between the inserting portion and the leading portion, to obtain excellent differential impedance matching.

### BRIEF DESCRIPTION OF THE DRAWINGS

FIG. 1 is the side view of the inserting portion of a traditional electrical connector configured in a staggered layout;

FIG. 2 is the outlook of the embodiment in accordance with the present invention;

FIG. 2A is the exploded view of the embodiment in accordance with the present invention;

FIG. 3 is the outlook of the inserting portion of the embodiment in accordance with the present invention;

FIG. 4A is the first contact of the embodiment in accordance with the present invention;

FIG. 4B is the second contact of the embodiment in accordance with the present invention;

FIG. 5 is the top view of the embodiment in accordance with the present invention;

FIG. 6 is the bottom view of the embodiment in accordance with the present invention;

FIG. 7 is the illustrative diagram of the configuration between the first contact and the second contact of the embodiment in accordance with the present invention;

FIG. 8 is the illustrative diagram of the comparison between the configuration of the traditional contact and the configuration of the first and the second contact of the embodiment in accordance with the present invention; and

FIG. 9 shows the testing results of the present invention and the traditional connector.

### DETAILED DESCRIPTION OF THE PREFERRED EMBODIMENTS

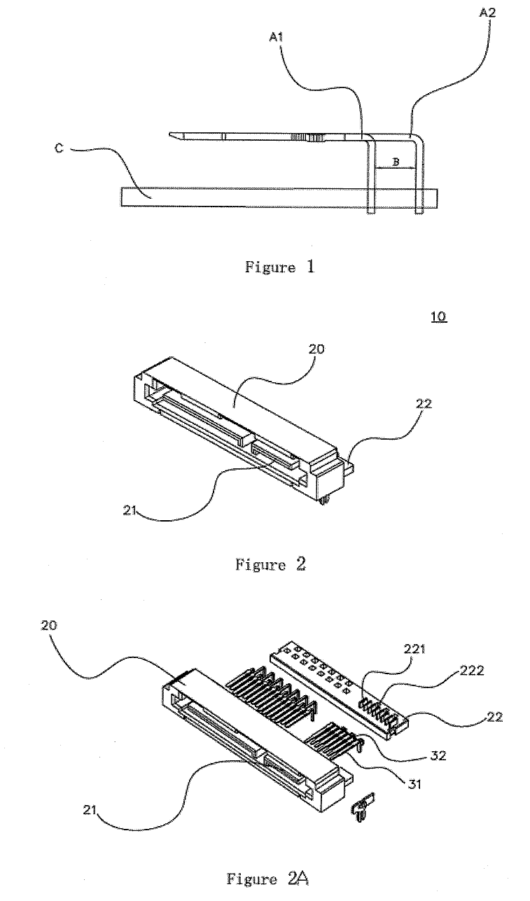

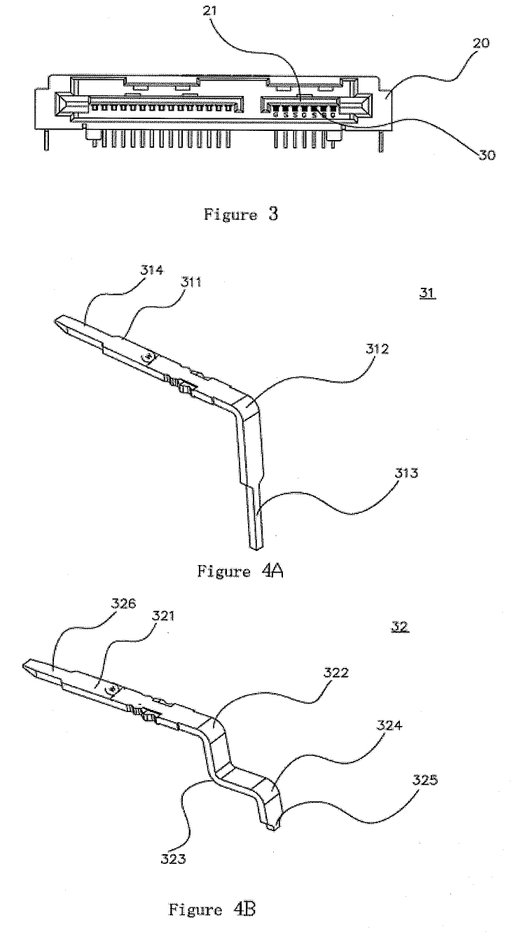

FIG. 2 is the outlook of the embodiment in accordance with the present invention. The present invention is an electrical connector 10 fixed on an electronic device 40, said electrical connector 10 comprising an insulating body 20 and a plurality of contacts 30, wherein said insulating body 20 includes an inserting portion 21, a leading portion 22 and a plurality of slots 23 which are passing between said inserting portion 21 and said leading portion 22. Further, all of the contacts 30 are conductors. Said contacts 30 were inserted between the inserting portion 21 and the leading portion 220 and the contacts were defined at least a ground contact (G) to separate each pair of signal contacts (S+, S−) in equal distance (As shown in FIG. 3).

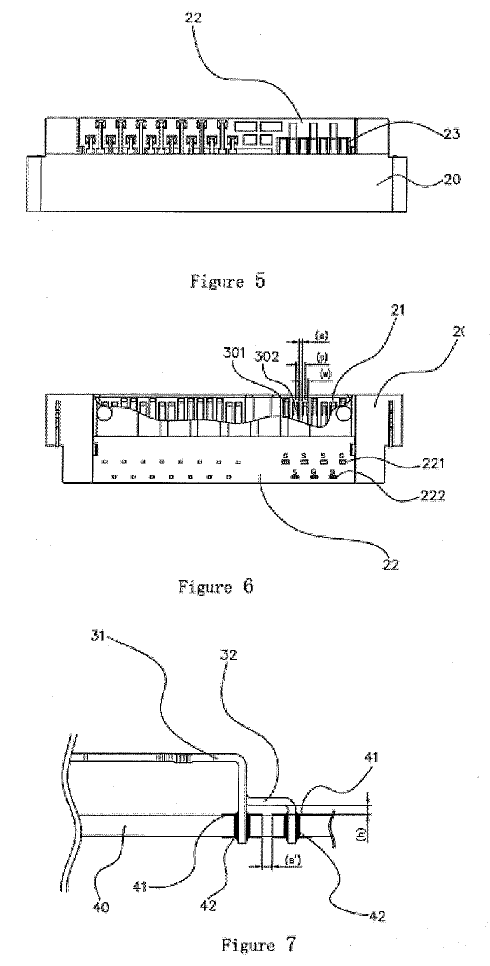

As shown in FIGS. 5 and 6, wherein the leading portion 22 comprises a first connection points array 221 and a second connection points array 222. Said connection points arrays include a ground contact (G) and two adjacent signal contacts (S+, S−), and, said ground contact (G) and said signal contacts (S+, S−) are arranged in staggered pattern between the first connection points array 221 and the second connection points array 222. Furthermore, the location of said ground contact (G) is disposed in the middle of those two adjacent signal contacts (S+, S−).

As shown in FIGS. 4A and 4B, said contacts 30 include a plurality of first contacts 31 located in each of the first connection points array 221 and a plurality of second contacts 32 located in each of the second connection points array 222 respectively, that is each of said second contacts 32 interposed between each of said first contacts 31 at different point array on leading portion 22.

Each of the first contacts 31 comprises a base 311 fixed inside each of said slots 23, a bending portion 312 bent downwardly from one end of the base 311, a tail portion 313 extended downwardly from the bending portion 312, and a contacting portion 314 formed on the other end of the base 311. The contacting portion 314 is fixed on the inserting portion 21 of the insulating body 20 for contacting electrically with each of the contacts of the corresponding connector, and, the tail portion 313 is electrically connected to a electronic device 40 by the slot3 23 of the leading portion 22 (as shown in FIG. 7).

Each of the second contacts 32 comprises a base 321 fixed within the slots 23, a first bending portion 322 bent downwardly from one end of the base 321, a second bending portion 323 bent forwardly from the lower end of the first bending portion 322, a third bending portion 324 bent downwardly from the outer end of the second bending portion 323, a tail portion 325 extended downwardly from the third bending portion 324 for connecting with an electronic device 40 electrically, and a contacting portion 326 formed on the other end of the base 321, wherein a horizontal portion 329 was formed between the second bending portion 323 and the third bending portion 324. The contacting portion 326 is also fixed on the inserting portion 21 of the insulating body 20 for contacting electrically with each of the contacts of the corresponding connector.

In general, the electronic device is a circuit board having a plurality of solder pads 41 arranged thereon. Each of solder pads 41 form a hole 42 to permit each tail portion 313 of the first contacts 31 and each tail portion 325 of the second contacts 32 to be inserted therein, and the solder pads 41 form a plurality of signal or ground path to permit the first contacts 31 or the second contacts 32 to be welded on each of the solder pads 41 by the leading portion 22 respectively.

The ideal differential characteristic impedance (Zdiff) of contacts 30 is satisfied between 100Ω±15%. The contacts forming each of the transmission paths between the inserting portion 21 and each of the solder pads 41 on the electronic device 40 are equal in order to achieve impedance matching therebetween, that is, a plurality of the first contacts 31 form the first transmission paths between each of the solder pads 41 of the electronic device 40 and the first connection points array 221; and a plurality of second contacts 32 form the second transmission paths between the second connection points array 222 and the electronic device 40.

As shown in FIGS. 6 and 7, each of the first transmission paths and each of the second transmission paths are spaced in equal distance one another, that is, the height (h) between the horizontal portion 329 of the second contact 32 and the electronic device 40 is almost equal to the space (s′) between the solder pads 41 of said electronic device 40.

Normally, the parameters that affect the differential characteristic impedance include: width (w) of conductor, space (s) between two conductors, thickness (t) of conductor and dielectric constant (∈r), etc. The formulae are shown as follows:

$$\begin{matrix}Zo = \frac{60}{\sqrt{0.475 ɛ r + 0.67}} ln ( \frac{4 h}{0.67 ( 0.8 w + t )} ) & Equation 1 \\ Zdiff = 2 Zo ( 1 - 0.48 {e}^{- 0.96 \frac{5}{8}} ) & Equation 2\end{matrix}$$

According to the above equations, the width (w) of conductor of the contact is in inverse proportion to the value of the differential characteristic impedance (Zdiff). That is, when the width (w) of both sides of each first contact 31 or each second contact 32 increases, the value of the differential characteristic impedance (Zdiff) decreases. On the contrary, while the width (w) decreases, the value of differential characteristic impedance (Zdiff) increases. Therefore, when the width (w) of conductor and the space (s) of two conductors are constant (suppose the value of differential characteristic impedance is within a ideal range between 100Ω±10%), and the pitch (p) of two contacts is 1.27 mm (p□2×w/2+s□ the amount of the width of each conductor add to the space of two conductors), wherein if the pitch (p) is a constant, the space (s) will increases when the width (w) decreases. As shown in FIG. 8, the deposition of the contacts of the present invention is different from that of a prior art, so, we can measure the value of differential characteristic impedance (Zdiff) of the present invention (F1) and that of the prior art (F2) by a Time Domain Reflectometry (TDR).

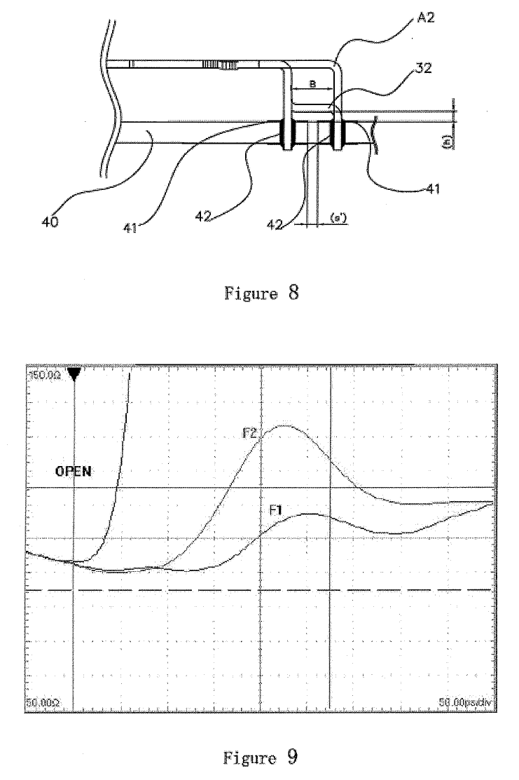

From the testing results (as shown in FIG. 9), we can find the differential characteristic impedance (Zdiff) of the prior art (F2) is around 133.16820. Obviously, it has exceeded the limitation of differential characteristic impedance (Zdiff) of 100Ω±15%. While in the present invention (F1), the testing result of the differential characteristic impedance (Zdiff) is around 107.33220. That is, the width (w) of both sides of the contacts is between 0.71-0.97 mm, and the space (s) of two contacts is 0.3-0.56 mm, which will satisfy the condition that the space between any central point of two contacts is 1.27 mm and the differential characteristic impedance (Zdiff) is between 100Ω±15%. Further, theoretically, the dimension error of the height (h) between the horizontal portion 329 of the second contacts and the electronic device and the space (s′) between two solder pads (s′) is within ±15%, the differential characteristic impedance will be in an ideal range. While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A high frequency connector disposed on an electronic device having a plurality of leading solder pads with equal interval therebetween each other, said connector comprising:
a plurality of first contacts; and
a plurality of second contacts, each of said second contacts being staggered each of said first contacts forming a space (s), and said second contacts having a horizontal portion; wherein the height (h) between the horizontal portion and the electronic device equals substantially the space (s′) between two adjacent solder pads for satisfying the condition of differential characteristic impedance value (Zdiff) between 100Ω±15% whatever the pitch (p) of said two contacts is increased.

2. The connector according to claim 1, wherein the dimension error of said height (h) and the space (s) is less than ±15%.

3. The connector according to claim 1, wherein the pitch (p) of two said contacts is equal to the amount of the width (w) and the space (s), if the pitch (p) is a constant, the space (s) will decreases when the width (w) increases or the space (s) will increases when the width (w) decreases.

4. The connector according to claim 1, wherein the transmission paths between said contacts and said electronic device are defined a ground contacts to separate each pair of signal contacts by an equal interval.

5. The connector according to claim 1, wherein said electronic device is a circuit board.

6. The connector according to claim 1, wherein said first contact has a base, a bending portion bent downwardly from one end of the base, and a tail portion extended downwardly from the bending portion for connecting electrically with said electronic device.

7. The connector according to claim 1, wherein said second contact has a base, a first bending portion bent downwardly from one end of the base, a second bending portion bent forwardly from the lower end of the first bending portion, a third bending portion bent downwardly from the outer end of the second bending portion, and a tail portion extended downwardly from the third bending portion for connecting with the electronic device electrically, meanwhile a horizontal portion was formed between the second bending portion and the third bending portion.

8. The connector according to claim 1, wherein the connector includes an inserting portion and a leading portion, the leading portion comprises a first connection points array and a second connection points array.

9. The connector according to claim 8, wherein each of said second contacts is interposed between each of said first contacts at different point array.
